(19) United States
(12) Patent Application Publication
(10) Pub. No.: US 2026/0024488 A1
(43) Pub. Date: Jan. 22, 2026

(54) DISPLAY PANEL AND DISPLAY DEVICE INCLUDING THE SAME

(71) Applicant: LG Display Co., Ltd., Seoul (KR)

(72) Inventors: Hyun Gi HONG, Paju-si (KR); Sang Jin NAM, Paju-si (KR); Seung Jin YOO, Paju-si (KR)

(73) Assignee: LG Display Co., Ltd., Seoul (KR)

(21) Appl. No.: 19/208,245

(22) Filed: May 14, 2025

(30) Foreign Application Priority Data
Jul. 19, 2024 (KR) 10-2024-0095567

(51) Int. Cl. G09G 3/32; G09G 3/3291

(52) U.S. Cl. CPC G09G 3/32; G09G 3/3291; G09G 2310/027; G09G 2310/0275; G09G 2330/021; G09G 2330/025

(57) ABSTRACT

The present disclosure relates to a display panel and a display device including the same. The display panel may include: data lines of a first pixel group to which a first data voltage is applied during a first sub-frame period and then a black grayscale voltage is applied during a second sub-frame period; data lines of a second pixel group to which the black grayscale voltage is applied during the first sub-frame period and then a second data voltage is applied during the second sub-frame period; sub-pixels of the first pixel group connected to the data lines of the first pixel group; and sub-pixels of the second pixel group connected to the data lines of the second pixel group.

### CROSS-REFERENCE TO RELATED APPLICATION

This application claims priority to and the benefit of Korean Patent Application No. 10-2024-0095567, filed Jul. 19, 2024, the disclosure of which is incorporated herein by reference in its entirety.

### BACKGROUND

### Technical Field

The present disclosure relates to a display panel and a display device including the same.

### Description of the Related Art

Various flat panel display devices, such as a liquid crystal display device and an electroluminescent display device, are known. The electroluminescent display device may use light emitting elements arranged in each pixel to emit light by itself without a backlight, thereby displaying an input image. The light emitting elements of the electroluminescent display device may be divided into an organic light emitting element and an inorganic light emitting element depending on the material of a light emitting layer.

Recently, a display device that uses a light emitting diode (LED), which is an inorganic light emitting element, as a light emitting element of a pixel has attracted attention as a next-generation display device. Since the LED is made of an inorganic material, it does not require a separate encapsulation layer to protect an organic material from moisture, and it has superior reliability and long lifespan compared to an organic light emitting diode (OLED). In addition, the LED has a fast light-up speed, excellent luminous efficiency, and impact resistance.

Micro LEDs have the characteristic of high luminous efficiency at high driving current. For this reason, a duty driving technology that drives a micro LED with a high current for a short time is required to drive the micro LED with high efficiency. The duty driving technology drives a micro LED with high current for a short time by lowering the percentage of the turn-on time of the micro LED within the emission period. This duty driving technique may reduce power consumption at the same target brightness compared to a driving method in which the micro LED continuously emits light with low current during the emission period, but since all pixels are turned on and off simultaneously, the peak current flowing through the wiring lines of the display panel may increase. In this case, constraints on the wiring and circuit design for the power lines of the display panel may increase, and the constant voltage applied to the pixels may fluctuate due to IR drop, which may deteriorate the image quality. IR drop refers to the voltage drop (V=IR) due to changes in current and resistance.

### BRIEF SUMMARY

The present disclosure provides a display panel capable of driving light-emitting elements at maximum luminous efficiency and reducing the peak current, and a display device including the same.

The technical features and characteristics of the present disclosure are not limited to those mentioned above, and other technical features or characteristics not mentioned will be clearly understood by those skilled in the art from the description below.

A display panel according to one embodiment of the present disclosure includes: data lines of a first pixel group to which a first data voltage is applied during a first sub-frame period and then a black grayscale voltage is applied during a second sub-frame period; data lines of a second pixel group to which the black grayscale voltage is applied during the first sub-frame period and then a second data voltage is applied during the second sub-frame period; sub-pixels of the first pixel group connected to the data lines of the first pixel group; and sub-pixels of the second pixel group connected to the data lines of the second pixel group.

During an emission period of the first sub-frame period, the sub-pixels of the first pixel group may be turned on, and the sub-pixels of the second pixel group may be turned off. During an emission period of the second sub-frame period, the sub-pixels of the first pixel group may be turned off, and the sub-pixels of the second pixel group may be turned on.

During a data addressing period of the first sub-frame period, the first data voltage may be applied to the sub-pixels of the first pixel group, and the black grayscale voltage may be applied to the sub-pixels of the second pixel group at the same time. During a data addressing period of the second sub-frame period, the black grayscale voltage may be applied to the sub-pixels of the first pixel group, and the second data voltage may be applied to the sub-pixels of the second pixel group at the same time.

The display panel may further include: a switch circuit that is connected to a first input node to which the first data voltage and the second data voltage are applied, a second input node to which the black grayscale voltage is input, gate nodes to which switch signals are applied, the data lines of the first pixel group, and the data lines of the second pixel group.

The switch circuit may include: a first switch part connected to a data line connected to a sub-pixel of a first color of a first pixel, and a data line connected to a sub-pixel of the first color of a second pixel adjacent to the first pixel; a second switch part connected to a data line connected to a sub-pixel of a second color of the first pixel, and a data line connected to a sub-pixel of the second color of the second pixel; and a third switch part connected to a data line connected to a sub-pixel of a third color of the first pixel, and a data line connected to a sub-pixel of the third color of the second pixel.

Each of the switch parts may include: a first transistor connected between the first input node and a data line of the first pixel group and turned on in response to a gate-on voltage of a first switch signal; a second transistor connected between the second input node and a data line of the first pixel group and turned on in response to a gate-on voltage of a second switch signal; a third transistor connected between the second input node and a data line of the second pixel group and turned on in response to the gate-on voltage of the first switch signal; and a fourth transistor connected between the first input node and a data line of the second pixel group and turned on in response to the gate-on voltage of the second switch signal.

A display panel according to another embodiment of the present disclosure includes: data lines of a first pixel group to which a first data voltage is applied during a first sub-frame period and then a black grayscale voltage is applied during a second sub-frame period and a third sub-frame period; data lines of a second pixel group to which a second data voltage is applied during the second sub-frame period and then the black grayscale voltage is applied during the first sub-frame period and the third sub-frame period; data lines of a third pixel group to which a third data voltage is applied during the third sub-frame period and then the black grayscale voltage is applied during the first sub-frame period and the second sub-frame period; sub-pixels of the first pixel group connected to the data lines of the first pixel group; sub-pixels of the second pixel group connected to the data lines of the second pixel group; and sub-pixels of the third pixel group connected to the data lines of the third pixel group.

During an emission period of the first sub-frame period, the sub-pixels of the first pixel group may be turned on, and the sub-pixels of the second pixel group and the sub-pixels of the third pixel group may be turned off. During an emission period of the second sub-frame period, the sub-pixels of the second pixel group may be turned on, and the sub-pixels of the first pixel group and the sub-pixels of the third pixel group may be turned off. During an emission period of the third sub-frame period, the sub-pixels of the third pixel group may be turned on, and the sub-pixels of the first pixel group and the sub-pixels of the second pixel group may be turned off.

During a data addressing period of the first sub-frame period, the first data voltage may be applied to the sub-pixels of the first pixel group, and the black grayscale voltage may be applied to the sub-pixels of the second pixel group and the sub-pixels of the third pixel group at the same time. During a data addressing period of the second sub-frame period, the second data voltage may be applied to the sub-pixels of the second pixel group, and the black grayscale voltage may be applied to the sub-pixels of the first pixel group and the sub-pixels of the third pixel group at the same time. During a data addressing period of the third sub-frame period, the third data voltage may be applied to the sub-pixels of the third pixel group, and the black grayscale voltage may be applied to the sub-pixels of the first pixel group and the sub-pixels of the second pixel group at the same time.

The display panel may further include: a switch circuit that is connected to a first input node to which the first data voltage, the second data voltage, and the third data voltage are applied, a second input node to which the black grayscale voltage is input, gate nodes to which switch signals are applied, the data lines of the first pixel group, the data lines of the second pixel group, and the data lines of the third pixel group.

The switch circuit may include: a first transistor connected between the first input node and a data line of the first pixel group and turned on in response to a gate-on voltage of a first switch signal; a second transistor connected between the second input node and a data line of the first pixel group and turned on in response to a gate-on voltage of a second switch signal; a third transistor connected between the second input node and a data line of the first pixel group and turned on in response to a gate-on voltage of a third switch signal; a fourth transistor connected between the second input node and a data line of the second pixel group and turned on in response to the gate-on voltage of the first switch signal; a fifth transistor connected between the first input node and a data line of the second pixel group and turned on in response to the gate-on voltage of the second switch signal; a sixth transistor connected between the second input node and a data line of the second pixel group and turned on in response to the gate-on voltage of the third switch signal; a seventh transistor connected between the second input node and a data line of the third pixel group and turned on in response to the gate-on voltage of the first switch signal; an eighth transistor connected between the second input node and a data line of the third pixel group and turned on in response to the gate-on voltage of the second switch signal; and a ninth transistor connected between the first input node and a data line of the third pixel group and turned on in response to the gate-on voltage of the third switch signal.

The switch circuit may include: a first transistor connected between the first input node and a data line of the first pixel group and turned on in response to a gate-on voltage of a first switch signal; a second transistor connected between the second input node and a data line of the first pixel group and turned on in response to a gate-on voltage of a fourth switch signal; a third transistor connected between the first input node and a data line of the second pixel group and turned on in response to a gate-on voltage of a second switch signal; a fourth transistor connected between the second input node and a data line of the second pixel group and turned on in response to a gate-on voltage of a fifth switch signal; a fifth transistor connected between the first input node and a data line of the third pixel group and turned on in response to a gate-on voltage of a third switch signal; and a sixth transistor connected between the second input node and a data line of the third pixel group and turned on in response to a gate-on voltage of a sixth switch signal.

A display device according to one embodiment of the present disclosure may include any one of the display panels described above.

According to an embodiment of the present specification, the light-emitting elements of individual colors may be driven at maximum luminous efficiency and the peak current may be lowered to reduce power consumption. Therefore, the present disclosure may drive the display device at low power.

The present disclosure may supply a black grayscale voltage to pixels for pixel duty driving and reduce the number of channels of the data driver.

The effects of the present disclosure are not limited to those mentioned above, and other effects not mentioned will be clearly understood by those skilled in the art from the description herein.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a diagram schematically showing an example of a switch circuit according to an embodiment of the present disclosure;

FIG. 3 is a circuit diagram schematically showing a pixel circuit according to an embodiment of the present disclosure;

FIG. 4 is a diagram showing an example of the current density-to-efficiency ratio characteristics of color-specific light-emitting elements;

FIG. 5 is a diagram showing an example of different duty rates of a micro LED at the same target luminance;

FIG. 6 is a diagram illustrating a duty driving method according to an embodiment of the present disclosure;

FIG. 7 is a waveform diagram showing an example of signals applied to data lines and gate lines during one frame period;

FIG. 8 is a diagram showing turned-on pixels and turned-off pixels in the duty driving method of FIG. 6;

FIG. 9 is a diagram illustrating a duty driving method according to another embodiment of the present disclosure;

FIG. 10 is a diagram showing turned-on pixels and turned-off pixels in the duty driving method of FIG. 9;

FIG. 11 is a diagram showing the current flowing in the power line of the display panel in the duty driving methods of FIG. 6 and FIG. 9;

FIG. 12 is a diagram showing an example of a switch circuit applicable to the duty driving methods of FIG. 6 and FIG. 9;

FIGS. 13A and 13B are diagrams illustrating the operation of the switch circuit illustrated in FIG. 12;

FIG. 14 is a waveform diagram showing an example of switch signals that control the switch circuit illustrated in FIG. 12;

FIG. 15 is a diagram showing a duty driving method according to another embodiment of the present disclosure;

FIG. 16 is a diagram showing turned-on pixels and turned-off pixels in the duty driving method of FIG. 15;

FIG. 17 is a diagram showing an example of a switch circuit applicable to the duty driving method of FIG. 15;

FIGS. 18A to 18C are diagrams illustrating the operation of the switch circuit illustrated in FIG. 17;

FIG. 19 is a waveform diagram showing an example of switch signals that control the switch circuit illustrated in FIG. 17;

FIGS. 20A to 20C are diagrams showing other examples of the switch circuit illustrated in FIG. 17; and

FIG. 21 is a waveform diagram showing an example of switch signals controlling the switch circuits illustrated in FIGS. 20A to 20C.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit of the display device may include a plurality of transistors. A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS)), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

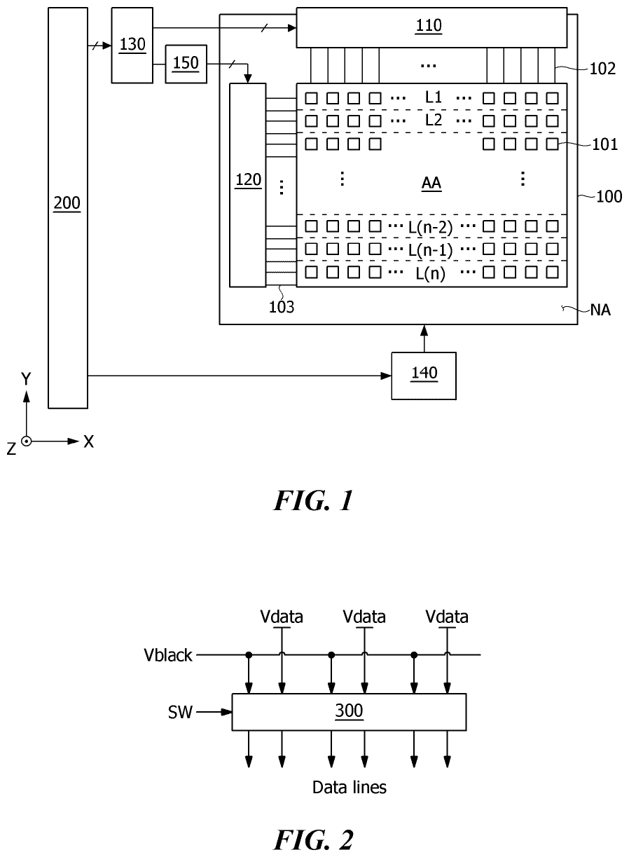

Referring to FIG. 1, a display device according to one embodiment of the present disclosure includes a display panel 100, a display panel driving circuit for writing pixel data to pixels 101 of the display panel 100, and a power supply 140 for generating power necessary for driving the pixels 101 and the display panel driving circuit.

A substrate of the display panel 100 may be a plastic substrate, a thin glass substrate, or a metal substrate, but is not limited thereto. The display panel 100 may be a rectangular panel having a length in an X-axis direction (or a first direction), a width in a Y-axis direction (or a second direction), and a thickness in a Z-axis direction (or a third direction), but is not limited thereto. For example, at least a portion of the display panel 100 may have a curved perimeter.

The display panel 100 may be implemented as a non-transmissive display panel or a transmissive display panel. The transmissive display panel may be applied to a transparent display device in which an image is displayed on a screen and a real object is visible beyond the display panel. The display panel 100 may be manufactured as a flexible display panel. In addition, the display panel 100 may be manufactured as a stretchable panel that can extend.

A display arca AA of the display panel 100 includes a pixel array for displaying an input image thereon. The display area AA includes a plurality of data lines 102, a plurality of gate lines 103 intersecting the data lines 102, and the pixels 101 arranged in a matrix form. The display panel 100 may further include power lines commonly connected to the pixels 101 and sensing lines. The power lines are commonly connected to the pixels and supply a constant voltage necessary for driving the pixels 101 to the pixels 101. The power lines may be implemented as long stripes of wires along either the first or second direction, or as mesh wires where the wires in the first direction and the wires in the second direction are electrically connected.

Each of the pixels 101 may be divided into a red (R) sub-pixel, a green (G) sub-pixel, and a blue (B) sub-pixel for color implementation. Each of the pixels may further include a white sub-pixel. Each sub-pixel includes a pixel circuit for driving a light-emitting element. Each of the pixel circuits is connected to the data lines, the gate lines, and the power lines. In the following, “pixel” may be interpreted as “sub-pixel.”

The data lines 102 may be divided into data lines of a first group of pixels to which a black grayscale voltage is applied during the second sub-frame period, and data lines of a second group of pixels to which a second data voltage corresponding to the pixel data of the input image is applied during the second sub-frame period, after the application of the black grayscale voltage during the first sub-frame period. The pixels may be divided into sub-pixels of the first group of pixels connected to the data lines of the first group of pixels and sub-pixels of the second group of pixels connected to the data lines of the second group of pixels.

The pixel array includes a plurality of pixel lines L1 to L(n). Each of the pixel lines L1 to L(n) includes one line of pixels arranged along the line direction (X-axis direction) in the pixel array of the display panel 100. The pixels arranged in one pixel line may share a gate line 103. The sub-pixels arranged in the column direction (Y-axis direction) along a data line direction may share the data line 102. One horizontal period is a time obtained by dividing one frame period by the total number of the pixel lines L1 to L(n).

The power supply 140 generates the constant voltages (or direct current (DC) voltages) required for driving the pixel array and the display panel driving circuit of the display panel 100 using a DC-DC converter. The DC-DC converter may include a charge pump, a regulator, a buck converter, a boost converter, and the like. The power supply 140 may adjust the level of the DC input voltage input from a host system 200 to output a gamma reference voltage, a gate-off voltage, a gate-on voltage, a pixel driving voltage, a pixel base voltage, and the like. The gamma reference voltage is supplied to the data driver 110. A dynamic range of the data voltage output from the data driver 110 is determined by a voltage range of the gamma reference voltage. The dynamic range of the data voltage is the range of voltages between the uppermost grayscale voltage and the lowermost grayscale voltage.

The gate-on voltage and the gate-off voltage are supplied to a level shifter 150 and the gate driver 120. The constant voltages such as the pixel driving voltage and the pixel base voltage are supplied to the pixels 101 via the power lines commonly connected to the pixels 101. The pixel base voltage may be, but is not limited to, the ground voltage. The pixel driving voltage may be supplied from a main power source of the host system 200 to the display panel 100. In this case, the power supply 140 does not need to output the pixel driving voltage.

The power supply 140 may output a black grayscale voltage. The black grayscale voltage is a voltage that is independent of pixel data of an input image. The black grayscale voltage may be applied to the data lines 102 at every frame period. A first transistor of the sub-pixel to which a black grayscale voltage is applied is turned off, turning off the light emitting element. The black grayscale voltage may be applied to the data lines 102 via the switch circuit 300 shown in FIG. 2. A switch circuit 300 may be embedded in an IC together with the data driver 110 or may be arranged in the non-display area NA of the display panel 100. The black grayscale voltage may be set to a voltage equal to, but not limited to, the voltage of the black grayscale or the lowest grayscale of the pixel data.

The display panel driving circuit writes pixel data of the input image to the pixels of the display panel 100 under the control of a timing controller 130. The display panel driving circuit includes the data driver 110 and the gate driver 120.

The display panel driving circuit may further include a touch sensor driver for driving touch sensors. The touch sensor driver is omitted in FIG. 1. The data driver 110 and the touch sensor driver may be integrated into a single drive integrated circuit (IC). The timing controller 130, the power supply 140, the level shifter 150, the data driver 110, the touch sensor driver, and the like may be further integrated into the drive IC.

The data driver 110 receives the pixel data of the input image received as a digital signal from the timing controller 130 and outputs the data voltage. The data driver 110 converts the pixel data of the input image into a gamma compensation voltage using a digital to analog converter (DAC) and outputs the data voltage. The gamma reference voltage is divided into gamma compensation voltages for each grayscale by a voltage divider circuit of the data driver 110 and supplied to the DAC. The DAC generates the data voltage with a gamma compensation voltage corresponding to a grayscale value of the pixel data. The data voltage outputted from the DAC is outputted to the data line 102 through an output buffer in each of data output channels of the data driver 110.

The data driver 110 may include sensing channels of an external compensation circuit electrically connected to the sensing lines of the display panel 100. The sensing channels may include an analog-to-digital converter (hereinafter referred to as the “ADC”) to convert a current or voltage from a sensing line into digital data and transmit the digital data to the timing controller 130.

The maximum emission efficiency intervals for each red, green, and blue light-emitting elements may have different data voltages. The data driver 110 may vary at least one of a dynamic range, a high voltage, and a low voltage of the red data voltage supplied to the red sub-pixel, the green data voltage supplied to the green sub-pixel, and the blue data voltage supplied to the blue sub-pixel to drive each of the red light emitting element, the green light emitting element, and the blue light emitting element at a maximum emission efficiency interval.

The gate driver 120 may be formed on the display panel 100. For example, the gate driver 120 may be arranged in the non-display area NA outside the display area AA in the display panel 100, or at least a portion thereof may be disposed in the display area AA.

The gate driver 120 may be disposed in either a left non-display area NA or a right non-display area NA outside the display area AA in the display panel 100 to supply the gate signal to the gate lines 103 in a single feeding method. In the single feeding method, the gate signal is applied to one ends of the gate lines. The gate driver 120 may be disposed in the left non-display area NA and the right non-display area NA in the display panel 100 to apply the gate signal to the gate lines 103 in a double feeding method. In the double feeding method, the gate signal is applied simultaneously to both ends of the gate lines 103. At least some circuits of the gate driver 120 may be disposed within the display area AA.

The gate driver 120 may output pulses of the gate signal and shift the pulses of the gate signal under the control of the timing controller 130 using the shift register.

The timing controller 130 receives the pixel data of the input image and a timing signal synchronized with the pixel data from the host system 200. The timing signal may include a vertical synchronization signal Vsync, a horizontal synchronization signal Hsync, and a data enable signal DE. A vertical period and a horizontal period may be known by counting the data enable signal DE, and thus the vertical synchronization signal Vsync and the horizontal synchronization signal Hsync may be omitted. The data enable signal DE has an interval of one horizontal period (1H).

The timing controller 130 may control the operation timings of the data driver 110 and the gate driver 120 based on the timing signals Vsync, Hsync, and DE received from the host system 200.

A gate timing control signal output from the timing controller 130 may be inputted to the shift register of the gate driver 120 through the level shifter 150. The level shifter 150 may receive the gate timing control signal and generate a clock to provide it to the gate driver 120. The input signal to the level shifter 150 is a signal of a digital signal voltage level. The clock output from the level shifter 150 may swing between the gate-high voltage and the gate-low voltage. A data timing control signal generated from the timing controller 130 is transmitted to the data driver 110.

The timing controller 130 may control each of the switch elements of the switch circuit 300 to switch the data voltage of the pixel data and the black grayscale voltage. In one example, the timing controller 130 may output switch signals that control the switch elements of the switch circuit 300. The voltage level of the switch signal may be shifted through the level shifter 150 and transmitted to the switch circuit or transmitted from the timing controller 130 to the switch circuit.

The host system 200 may scale an image signal from a video source to match the resolution of the display panel 100, and may transmit it to the timing controller 130 together with the timing control signal.

FIG. 2 is a diagram schematically showing an example of a switch circuit according to an embodiment of the present disclosure.

Referring to FIG. 2, the switch circuit 300 may use a plurality of switch elements to supply, in response to a switch signal SW, a data voltage Vdata of pixel data to data lines connected to sub-pixels of a first pixel group and a black grayscale voltage Vblack to data lines connected to sub-pixels of a second pixel group at the same time.

The sub-pixels of the first pixel group and the second pixel group may be turned on according to the data voltage Vdata and turned off according to the black grayscale voltage Vblack. The first pixel group that is turned on during the first frame period or first sub-frame period may be turned off during the second frame period or second sub-frame period. The second pixel group that is turned off during the first frame period or first sub-frame period may be turned on during the second frame period or second sub-frame period. The number and size of sub-pixels belonging to cach pixel group may be determined according to the preset duty rate.

The switch circuit 300 may be embedded in the data driver 110. For example, the switch elements of the switch circuit 300 may be connected between the output buffer and the output terminal of the data driver 110.

The switch circuit 300 may be arranged in the non-display area of the display panel 100. For example, the switch elements of the switch circuit 300 may be arranged in the upper or lower non-display area of the display panel 100 so as to be connected between the output terminals of the data driver 110 and the data lines 102. Additionally, the switch elements of the switch circuit 300 may be distributed in the upper non-display area and the lower non-display area of the display panel 100.

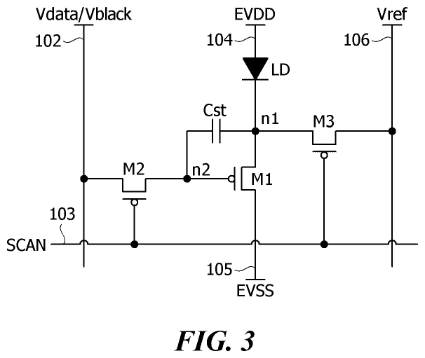

FIG. 3 is a circuit diagram schematically showing a pixel circuit according to an embodiment of the present disclosure.

Referring to FIG. 3, the pixel circuit includes a light-emitting element LD, a first transistor M1 driving the light-emitting clement LD, a second transistor M2, a third transistor M3, and a capacitor Cst. The transistors M1, M2 and M3 may be implemented with, but not limited to, p-channel transistors.

The pixel circuit is connected to the data lines to which the data voltage Vdata is applied, the gate lines to which the gate signal SCAN is applied, and constant voltage nodes to which a DC voltage (or constant voltage) is applied, such as the VDD node 104 to which the pixel driving voltage EVDD is applied and the VSS node 105 to which the pixel ground voltage EVSS is applied. The constant voltage nodes may be connected to the power lines arranged on the display panel (100), and the power lines may be commonly connected to all pixels.

The data voltage Vdata may be, but not limited to, a voltage corresponding to the grayscale value of the pixel data selected from a dynamic range voltage between 0 and 16 V. The reference voltage Vref may be, but not limited to, a voltage selected from a voltage range between 7 and 11 V. The pixel driving voltage EVDD may be, but not limited to, a voltage selected from a voltage range between 6 and 12 V, and the pixel ground voltage EVSS may be, but not limited to, 0 V. The gate-off voltage VGH of the gate signal SCAN may be set to, but not limited to, a voltage selected from a range between 12 and 20 V, and the gate-on voltage VGL may be set to, but not limited to, a voltage selected from a range between −19 and −12 V.

The first transistor M1 includes a first electrode connected to the first node n1, a gate electrode connected to the second node n2, and a second electrode connected to the VSS node 105. The light-emitting element LD includes an anode electrode connected to the VDD node 104 and a cathode electrode connected to the first node n1. The light-emitting element LD may be, but not limited to, a micro LED. The capacitor Cst is connected between the first node n1 and the second node n2 to charge the gate-source voltage of the first transistor M1.

The second transistor M2 is connected between the data line 102 to which the data voltage Vdata or black grayscale voltage Vblack is applied, and the second node n2, and is turned on in response to the gate-on voltage of the gate signal SCAN. When the second transistor M2 is turned on, the black grayscale voltage Vblack is applied to the second node n2. The second transistor M2 includes a first electrode connected to the data line 102, a second electrode connected to the second node n2, and a gate electrode connected to the gate line 103 to which the gate signal SCAN is applied. The second transistor M2 may be implemented with, but not limited to, a dual gate structure in which two transistors are connected in series to reduce leakage current.

The third transistor M3 is connected between the sensing line 106 to which the reference voltage Vref is applied and the first node n1, and is turned on in response to the gate-on voltage of the gate signal SCAN. When the third transistor M3 is turned on, the first node n1 may be electrically connected to the sensing line 106. The third transistor M3 includes a first electrode connected to the first node n1, a second electrode connected to the sensing line 106, and a gate electrode connected to the gate line 103 to which the gate signal SCAN is applied.

The sensing line 106 may be connected to the sensing channel of the data driver 110. The ADC of the sensing channel may be connected to the compensation circuit of the timing controller 130. The external compensation circuit includes an ADC connected to the sensing line, and a compensation circuit that modulates pixel data with a compensation value selected according to digital data input from the ADC. The current or voltage sensed through the sensing line 106 is converted into digital data through the ADC and input to the compensation circuit of the timing controller 130. The external compensation circuit may sense the electrical characteristics, such as threshold voltage and mobility, of the first transistor M1 used as the driving element of the light-emitting element LD in each sub-pixel through the sensing line 106, and modulate pixel data (digital data) of the input image as much as the electrical characteristic deviation (or change) of the first transistor M1 to thereby compensate for the electrical characteristic deviation (or change) of the first transistor M1 in each pixel in real time.

The display device of the present disclosure may reduce the IR drop of a constant voltage, for example, the pixel driving voltage, applied through the power line by reducing the number of light-emitting elements LD that emit light simultaneously and reducing the peak current correspondingly.

The display panel driving circuit performs duty-driving on pixels to drive light-emitting elements at the maximum luminous efficiency of the light-emitting element LD. The duty driving method of the present disclosure divides one frame period in time into two or more sub-frame periods. The sub-frame period may be divided into a data addressing period in which sub-pixels are charged with the data voltage Vdata or black grayscale voltage Vblack corresponding to the pixel data of the input image, and an emission period in which sub-pixels are turned on or off by group. During the emission period, sub-pixels charged with the data voltage Vdata emit light, while sub-pixels charged with the black grayscale voltage Vblack are turned off. The sub-frame period and emission period may be determined according to the preset duty rate.

Each of the sub-pixels may emit light with a luminance that varies depending on the voltage of the data voltage Vdata applied to the data line 102, and may be turned off according to the black grayscale voltage Vblack applied to the data line 102. In the display device of the present disclosure, to reduce the peak current flowing through the wiring of the display panel, for example, the power line, not all pixels are turned on simultaneously but pixels are turned on in sequence with a time difference on the time axis.

The grayscale of pixels may be expressed as luminance in pixels according to the voltage level or amplitude of the data voltage selected based on the grayscale value of the pixel data. Therefore, the grayscale of the pixels is expressed by pulse amplitude modulation (PAM) during the turn-on period, and the duty driving of the pixels is controlled by pulse width modulation (PWM) that defines the ratio between the turn-on period and the turn-off period.

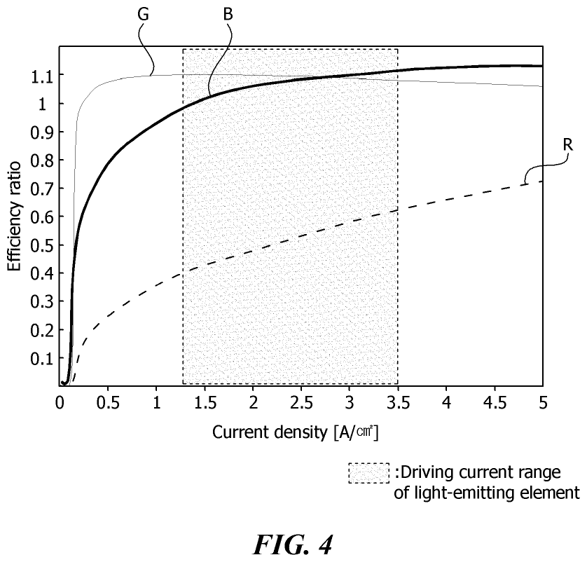

FIG. 4 is a diagram showing an example of the current density-to-efficiency ratio characteristics of color-specific micro LEDs. In FIG. 4, the horizontal axis indicates the current density (A/Cm²), and the vertical axis indicates the efficiency ratio compared to the reference efficiency for the light-emitting element of each color when the reference efficiency is ‘1.’ The current density-to-efficiency ratio of the color-specific light-emitting element illustrated in FIG. 4 is a normalized value. As shown in FIG. 4, the maximum luminous efficiency ranges of the micro LED of the red sub-pixel, the micro LED of the green sub-pixel, and the micro LED of the blue sub-pixel may be different from each other. For each color, power consumption may be reduced when the driving current range of the micro LED is set within the maximum luminous efficiency range.

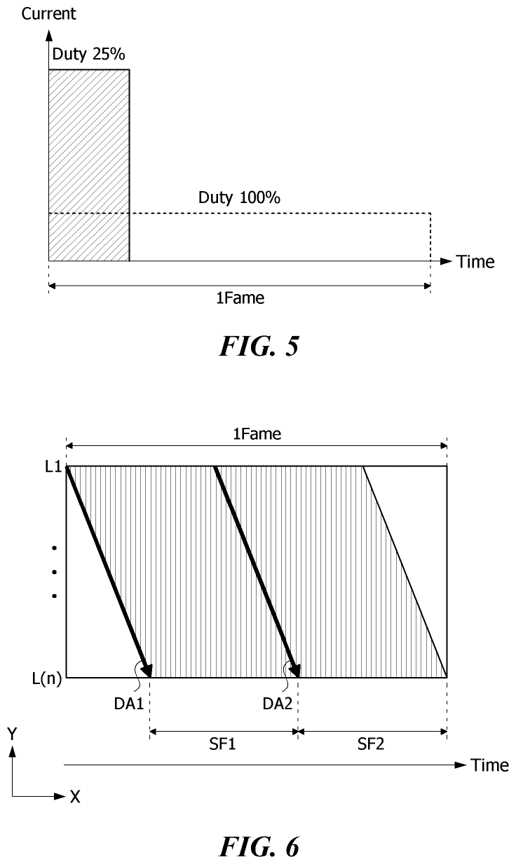

FIG. 5 is a diagram showing an example of different duty rates of a micro LED at the same target luminance. In FIG. 5, the horizontal axis indicates time and the vertical axis indicates current.

The luminance of a pixel may be expressed as “time×current” because it increases as the turn-on time of the micro LED used as the light-emitting element LD increases and the current flowing through the light-emitting element increases, as shown in FIG. 5. Since the luminous efficiency of the micro LED is high when being driven at high current density for a short time, the power consumption at the same target luminance may be reduced compared to when being driven at a low current for a long time. For example, the micro LED of the turned-on pixel emits light for approximately 1 frame period when the duty rate is 100 percent as indicated by the solid line, and for approximately ¼ frame period when the duty ratio is 25 percent as indicated by the dotted line. The micro LED of the turned-on pixel emits light for approximately ½ frame period when the duty rate is 50 percent. Experiments have shown that when reaching the same target luminance, for example, 600 nits in one frame period, the power consumption of the micro LED is reduced by 43 percent when the duty rate is 25% compared to a duty rate of 100 percent.

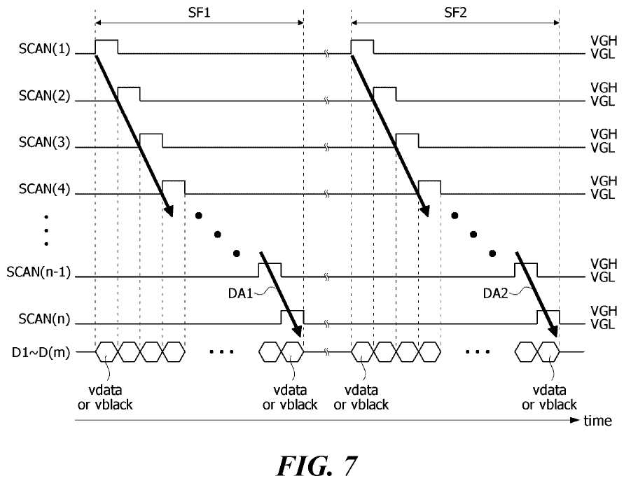

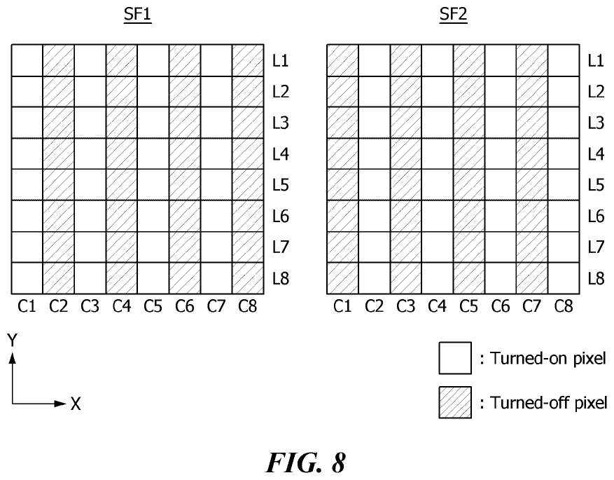

FIG. 6 is a diagram illustrating a duty driving method according to an embodiment of the present disclosure. FIG. 7 is a waveform diagram showing an example of signals applied to data lines and gate lines during one frame period. In FIG. 7, ‘VGL’ indicates the gate-on voltage of the gate signal, and ‘VGH’ indicates the gate-off voltage of the gate signal. FIG. 8 is a diagram showing turned-on pixels and turned-off pixels in the duty driving method of FIG. 6.

Referring to FIGS. 6 to 8, the pixels of the display panel may be driven at a duty rate of 50 percent. In this case, one frame period may be divided in time into a first sub-frame period SF1 and a second sub-frame period SF2. When the frequency of the input image is 120 Hz, one frame period may be approximately 8.3 ms, and each of the first and second sub-frame periods SF1 and SF2 may be approximately 4.15 ms.

The sub-pixels of the first pixel group may be turned on by receiving the data voltage (Vdata) applied to the data line during the first sub-frame period SF1, and may be turned off by receiving the black grayscale voltage Vblack applied to the data line during the second sub-frame period SF2. The sub-pixels of the second pixel group may be turned off by receiving the black grayscale voltage Vblack applied to the data line during the first sub-frame period SF1, and may be turned off by receiving the data voltage Vdata applied to the data line during the second sub-frame period SF2.

The sub-pixels of the first and second pixel groups are charged with the data voltage Vdata or black grayscale voltage Vblack in response to the pulses of the gate signals SCAN1 to SCAN(n) that are sequentially shifted in units of one pixel line as illustrated in FIG. 7. In FIGS. 6 and 7, ‘DA1’ represents a first data addressing direction in which pixel data and black data are written to sub-pixels during the first sub-frame, and ‘DA2’ represents a second data addressing direction in which pixel data and black data are written to sub-pixels during the second sub-frame. During the first sub-frame period SF1, the sub-pixels of the first pixel group may be turned on after first data addressing. During the second sub-frame period SF2, the sub-pixels of the second pixel group may be turned on after second data addressing. Data addressing may be interpreted as pixel scanning or data programming. In FIG. 7, ‘D1˜D (m)’ represents the 1^{st} to m^{th} (m is a natural number greater than or equal to 2) data lines.

As shown in FIGS. 6 and 8, the first pixel group including sub-pixels arranged in odd-numbered column lines C1, C3 . . . C7 may be turned on during the first sub-frame period SF1 and turned off during the second sub-frame period SF2. The second pixel group including sub-pixels arranged in even-numbered column lines C2, C4 . . . C8 may be turned off during the first sub-frame period SF1 and turned on during the second sub-frame period SF2. In FIG. 8, C1 to C8 are the first to eighth column lines, and L1 to L8 are the first to eighth pixel lines.

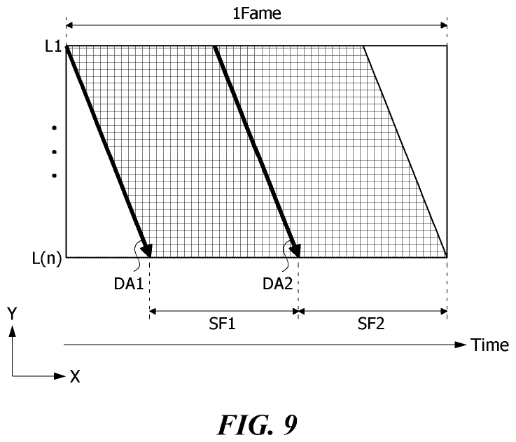

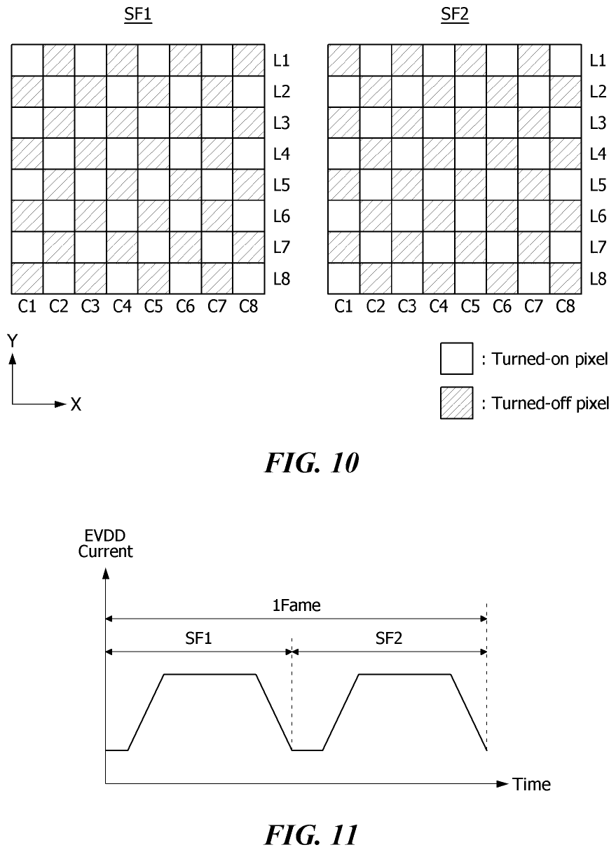

FIG. 9 is a diagram illustrating a duty driving method according to another embodiment of the present disclosure. FIG. 10 is a diagram showing turned-on pixels and turned-off pixels in the duty driving method of FIG. 9. In this embodiment, descriptions that are substantially the same as or overlapping with the above-described embodiment will be omitted.

Referring to FIGS. 9 and 10, the first pixel group including odd-numbered sub-pixels of odd-numbered pixel lines L1, L3 . . . L7 and even-numbered sub-pixels of even-numbered pixel lines L2, L4 . . . L8 may be turned on during the first sub-frame period SF1 and turned off during the second sub-frame period SF2. The second pixel group including odd-numbered sub-pixels of odd-numbered pixel lines L1, L3 . . . L7 and odd-numbered sub-pixels of even-numbered pixel lines L2, L4 . . . L8 may be turned off during the first sub-frame period SF1 and turned on during the second sub-frame period SF2.

In the duty driving method illustrated in FIG. 6 and FIG. 9, half of the sub-pixels among the entire sub-pixels may be turned on during the first sub-frame period SF1, and the remaining half of the sub-pixels may be turned on during the second sub-frame period SF2. As a result, as shown in FIG. 11, the current flowing through the power lines of the display panel during one frame period is distributed over the time axis, so that the peak current may be reduced to approximately half or less compared to when all sub-pixels are turned on simultaneously.

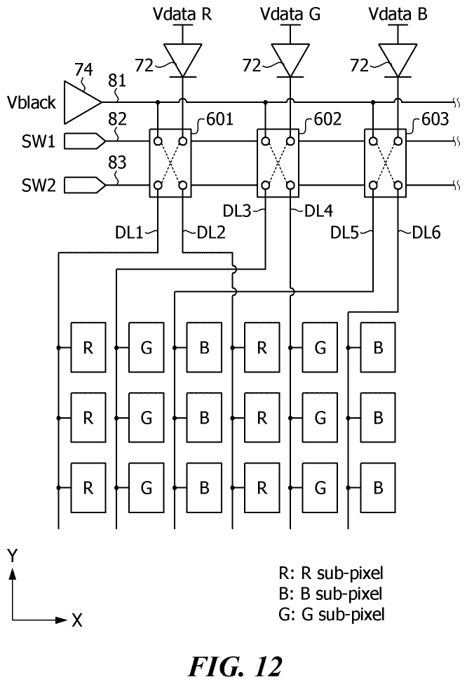

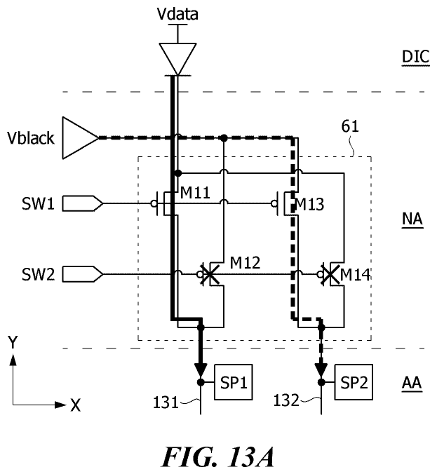

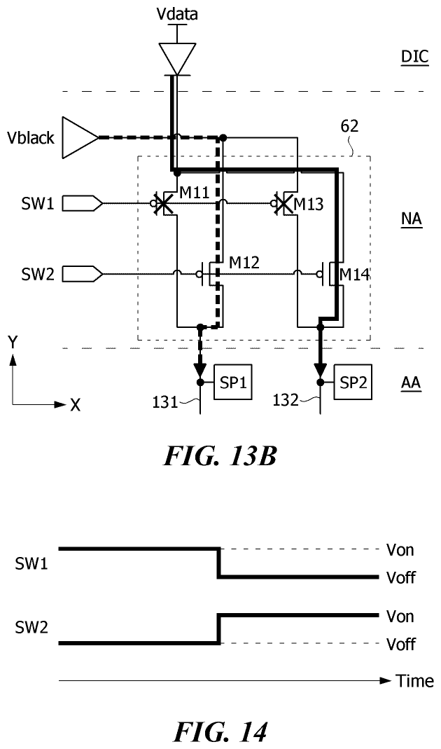

FIG. 12 is a diagram showing an example of a switch circuit applicable to the duty driving methods of FIG. 6 and FIG. 9. FIGS. 13A and 13B are diagrams illustrating the operation of the switch circuit shown in FIG. 12. In FIGS. 13A and 13B, ‘DIC’ indicates a drive IC in which the data driver 110 is integrated. The switch elements M11 to M14 of the switch circuit 300 may be arranged in, but not limited to, the non-display area NA of the display panel 100 as shown in FIGS. 13A and 13B. FIG. 14 is a waveform diagram showing an example of switch signals that control the switch circuit illustrated in FIG. 12.

Referring to FIGS. 12 to 14, the switch circuit 300 includes a plurality of switch parts 61, 62 and 63. Each of the switch parts 61, 62 and 63 may include a plurality of transistors.

Each of the switch parts 61, 62 and 63 of the switch circuit 300 is connected to a first input node to which data voltages VdataR, VdataG and VdataB are applied, a second input node connected to a common line 81 to which the black grayscale voltage Vblack is applied, a first gate node connected to a first switch signal line 82 to which a first switch signal SW1 is applied, and a second gate node connected to a second switch signal line 83 to which a second switch signal SW2 is applied.

The data lines DL1, DL3 and DL5 of the first pixel group may include odd-numbered data lines connected to the sub-pixels R, G and B of the first pixel group. The data lines DL2, DL4 and DL6 of the second pixel group may include even-numbered data lines connected to the sub-pixels R, G and B of the second pixel group. The data voltages VdataR, VdataG, and VdataB may be applied to the first input nodes of the switch parts 61, 62 and 63 through the output buffer 72 of the data driver 110. The black grayscale voltage Vblack may be applied to the second input nodes of the switch parts 61, 62 and 63 through the output buffer 74 of the power supply 140.

When the switch circuit 300 is connected to the output terminals of the data driver 110, the number of channels of the data driver 110 may be reduced. As shown in FIG. 12, since the data voltage output from the data driver 110 may be applied to two data lines through the switch parts 61, 62 and 63, the number of channels of the data driver 110 may be reduced by half compared to the number of data lines.

The switch parts 61, 62 and 63 may be electrically connected to sub-pixels of the same colors in adjacent pixels. For example, the first switch part 61 may be connected to the first data line (DL1), and the first data line DL1 may be connected to red sub-pixels R of first pixels. The first switch part 61 may be connected to the second data line DL2, and the second data line DL2 may be connected to red sub-pixels R of second pixels. The second switch part 62 may be connected to the third data line DL3, and the third data line DL3 may be connected to green sub-pixels G of first pixels. The second switch part 62 may be connected to the fourth data line DL4, and the fourth data line DL4 may be connected to green sub-pixels G of second pixels. The third switch part 63 may be connected to the fifth data line DL5, and the fifth data line DL5 may be connected to blue sub-pixels B of first pixels. The third switch part 63 may be connected to the sixth data line DL6, and the sixth data line DL6 may be connected to blue sub-pixels B of second pixels.

Each of the switch parts 61, 62 and 63 includes first to fourth transistors M11 to M14 as shown in FIGS. 13A and 13B. The transistors M11 to M14 are turned on in response to the gate-on voltage Von of the switch signals SW1 and SW2, and are turned off in response to the gate-off voltage Voff of the switch signals SW1 and SW2. As shown in FIG. 14, the phases of the first switch signal SW1 and the second switch signal SW2 may be anti-phases each other. When the voltage of the first switch signal SW1 is the gate-on voltage Von, the voltage of the second switch signal SW2 may be the gate-off voltage Voff. When the voltage of the second switch signal SW2 is the gate-on voltage Von, the voltage of the first switch signal SW1 may be the gate-off voltage Voff.

The first transistor M11 is connected between the first input node to which the data voltage Vdata is applied and the first data line 131 as shown in FIGS. 13A and 13B, and is turned on in response to the gate-on voltage Von of the first switch signal SW1. The first data line 131 may be a data line of the first pixel group. When the first transistor M11 is turned on, the data voltage Vdata may be applied to the sub-pixel SP1 of the first pixel group through the first data line 131. The first transistor M11 includes a first electrode connected to the first input node, a second electrode connected to the first data line 131, and a gate electrode connected to the first gate node to which the first switch signal SW1 is applied.

The second transistor M12 is connected between the second input node to which the black grayscale voltage Vblack is applied and the first data line 131 as shown in FIGS. 13A and 13B, and is turned on in response to the gate-on voltage Von of the second switch signal SW2. When the second transistor M12 is turned on, the black grayscale voltage Vblack may be applied to the sub-pixel SP1 of the first pixel group through the first data line 131. The second transistor M12 includes a first electrode connected to the second input node, a second electrode connected to the first data line 131, and a gate electrode connected to the second gate node to which the second switch signal SW2 is applied.

The third transistor M13 is connected between the second input node and the second data line 132 as shown in FIGS. 13A and 13B, and is turned on in response to the gate-on voltage Von of the first switch signal SW1. The second data line 132 may be a data line of the second pixel group. When the third transistor M13 is turned on, the black grayscale voltage Vblack may be applied to the sub-pixel SP2 of the second pixel group through the second data line 132. The third transistor M13 includes a first electrode connected to the second input node, a second electrode connected to the second data line 132, and a gate electrode connected to the first gate node.

The fourth transistor M12 is connected between the first input node and the second data line 132 as shown in FIGS. 13A and 13B, and is turned on in response to the gate-on voltage Von of the second switch signal SW2. When the fourth transistor M14 is turned on, the data voltage Vdata may be applied to the second sub-pixel SP2 through the second data line 132. The fourth transistor M14 includes a first electrode connected to the first input node, a second electrode connected to the second data line 132, and a gate electrode connected to the second gate node.

As shown in FIG. 13A, during the data addressing period of the first sub-frame period SF1, the first data voltage Vdata may be applied to the sub-pixel SP1 of the first pixel group, and at the same time, the black grayscale voltage Vblack may be applied to the sub-pixel SP2 of the second pixel group. The first data voltage Vdata may be a data voltage corresponding to pixel data written to the sub-pixels SP1 of the first pixel group. Next, as shown in FIG. 13B, during the data addressing period of the second sub-frame period SF2, the black grayscale voltage Vblack may be applied to the sub-pixel SP1 of the first pixel group, and at the same time, the second data voltage Vdata may be applied to the sub-pixel SP2 of the second pixel group. The second data voltage Vdata may be a data voltage corresponding to pixel data written to the sub-pixels SP2 of the second pixel group.

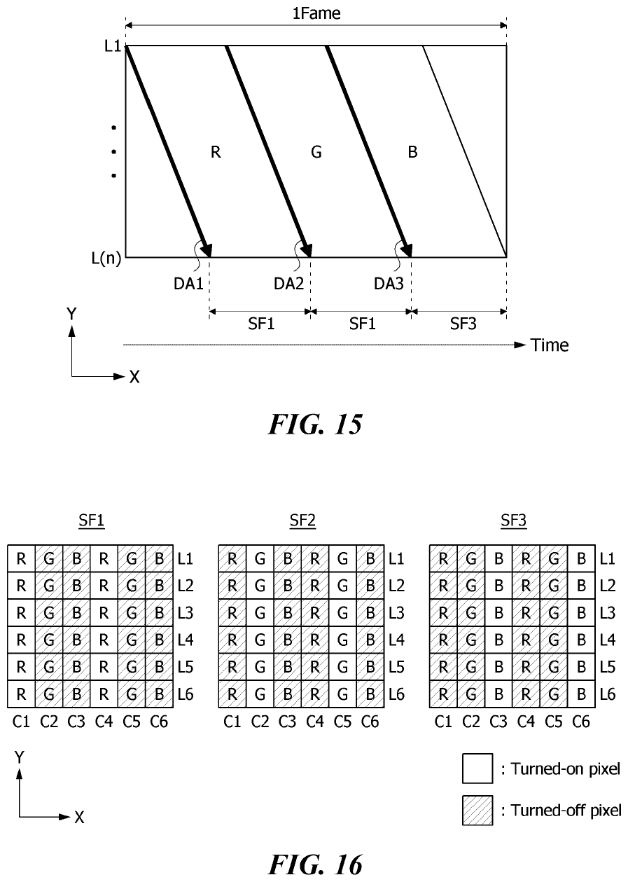

FIG. 15 is a diagram showing a duty driving method according to another embodiment of the present disclosure. In FIG. 15, ‘DA1’ indicates a first data addressing direction in which pixel data and black data are written to sub-pixels during the first sub-frame. ‘DA2’ indicates a second data addressing direction in which pixel data and black data are written to sub-pixels during the second sub-frame. ‘DA3’ indicates third data addressing in which pixel data and black data are written to sub-pixels during the third sub-frame. FIG. 16 is a diagram showing turned-on pixels and turned-off pixels in the duty driving method of FIG. 15. In FIGS. 16, C1 to C8 are the first to eighth column lines, and L1 to L8 are the first to eighth pixel lines.

Referring to FIGS. 15 and 16, one frame period may be divided in time into a first sub-frame period SF1, a second sub-frame period SF2, and a third sub-frame period SF3.

During the first sub-frame period SF1, a first pixel group including ⅓ of the total sub-pixels may be turned on, then during the second sub-frame period SF2, a second pixel group including another ⅓ of the sub-pixels may be turned on, and then during the third sub-frame period SF3, a third pixel group including the remaining ⅓ of the sub-pixels may be turned on.

The first pixel group may include sub-pixels of a first color, for example, red sub-pixels. The second pixel group may include sub-pixels of a second color, for example, green sub-pixels. The third pixel group may include sub-pixels of a third color, for example, blue sub-pixels. During the first sub-frame period SF1, the green and blue sub-pixels G and B may be turned off by receiving the black grayscale voltage Vblack, and the red sub-pixels R may be turned on by receiving the data voltage Vdata. During the second sub-frame period SF2, the red and blue sub-pixels R and B may be turned off by receiving the black grayscale voltage Vblack, and the green sub-pixels G may be turned on by receiving the data voltage Vdata. During the third sub-frame period SF3, the red and green sub-pixels R and G may be turned off by receiving the black grayscale voltage Vblack, and the blue sub-pixels B may be turned on by receiving the data voltage Vdata. According to this duty driving method, the current flowing through the power lines of the display panel during one frame period is distributed over the time axis, so that the peak current may be reduced to approximately ⅓ or less compared to a case where all sub-pixels are turned on simultaneously.

During the data addressing period of the first sub-frame period SF1, the first data voltage may be applied to the data lines of the first pixel group, and then the sub-pixels of the first pixel group may be turned on during the emission period. During the data addressing period of the second sub-frame period SF2 and the third sub-frame period SF3, the black grayscale voltage may be applied to the data lines of the first pixel group. The data lines of the first pixel group are connected to the sub-pixels of the first pixel group. During the data addressing period of the second sub-frame period SF2, the second data voltage may be applied to the data lines of the second pixel group, and then the sub-pixels of the second pixel group may be turned on during the emission period. During the data addressing period of the first sub-frame period SF1 and the third sub-frame period SF3, the black grayscale voltage may be applied to the data lines of the second pixel group. The data lines of the second pixel group are connected to the sub-pixels of the second pixel group. During the data addressing period of the third sub-frame period SF3, the third data voltage may be applied to the data lines of the third pixel group, and then the sub-pixels of the third pixel group may be turned on during the emission period. During the data addressing period of the first sub-frame period SF1 and the second sub-frame period SF2, the black grayscale voltage may be applied to the data lines of the third pixel group. The data lines of the third pixel group are connected to the sub-pixels of the third pixel group.

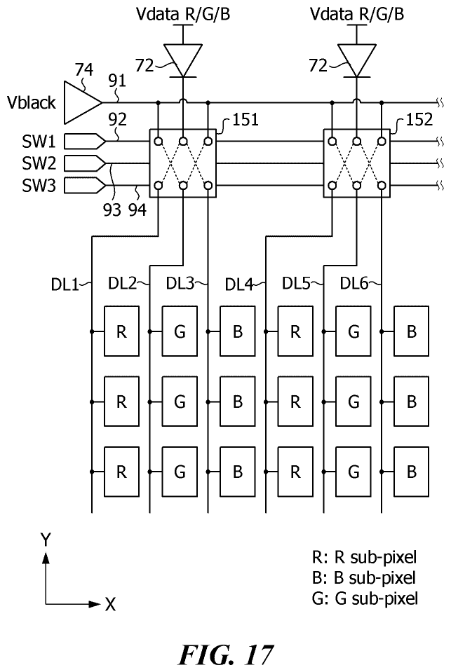

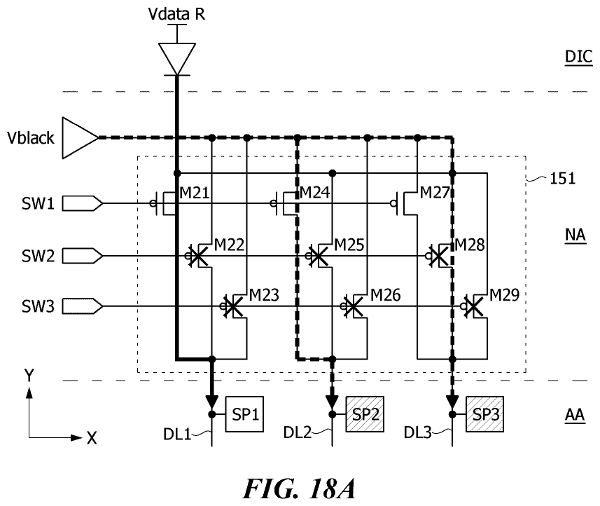

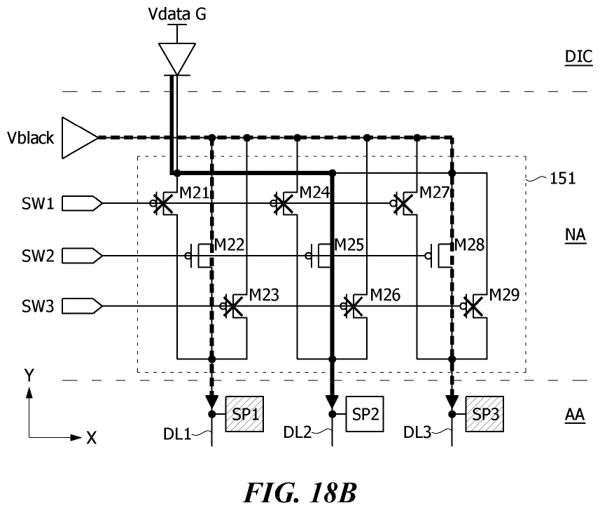

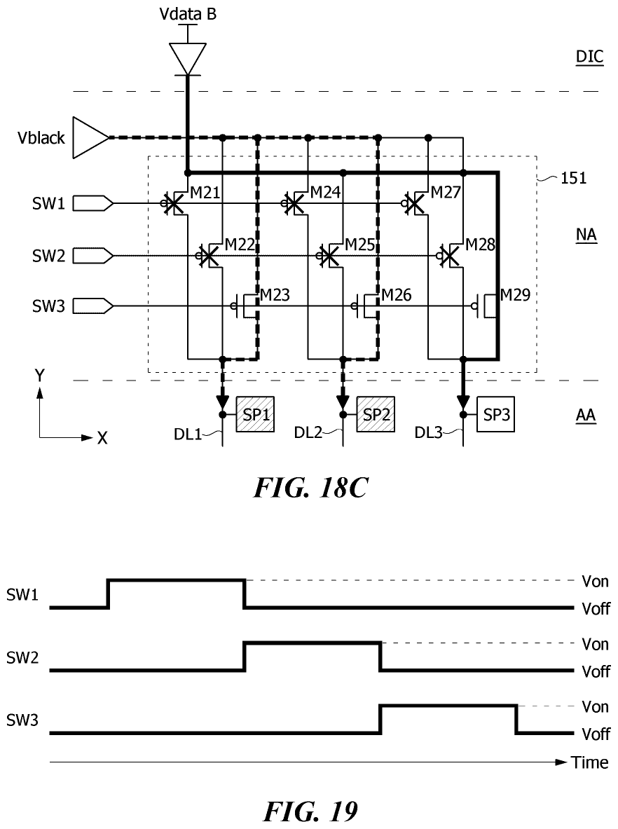

FIG. 17 is a diagram showing an example of a switch circuit applicable to the duty driving method of FIG. 15. FIGS. 18A to 18C are diagrams illustrating the operation of the switch circuit illustrated in FIG. 17. In FIGS. 18A to 18C, ‘DIC’ indicates a drive IC in which the data driver 110 is integrated. The switch elements M21 to M29 of the switch circuit 300 may be arranged in, but not limited to, the non-display area NA of the display panel 100 as shown in FIGS. 18A to 18C. FIG. 19 is a waveform diagram showing an example of switch signals that control the switch circuit illustrated in FIG. 17.

Referring to FIGS. 17 to 19, the switch circuit 300 includes a plurality of switch parts 151 and 152. Each of the switch parts 151 and 152 may include a plurality of transistors.

Each of the switch parts 151 and 152 of the switch circuit 300 is connected to a first input node to which the data voltage VdataR/G/B is applied, a second input node connected to a common line 91 to which the black grayscale voltage Vblack is applied, a first gate node connected to a first switch signal line 92 to which the first switch signal SW1 is applied, a second gate node connected to a second switch signal line 93 to which the second switch signal SW2 is applied, a third gate node connected to a third switch signal line 94 to which the third switch signal SW3 is applied, data lines DL1 and DL4 of the first pixel group, data lines DL2 and DL5 of the second pixel group, and data lines DL3 and DL6 of the third pixel group. The data lines DL1 and DL4 of the first pixel group may be connected to the sub-pixels SP1 of the first pixel group, for example, the red sub-pixels R. The data lines DL2 and DL4 of the second pixel group may be connected to the sub-pixels SP2 of the second pixel group, for example, the green sub-pixels G. The data lines DL3 and DL6 of the third pixel group may be connected to the sub-pixels SP3 of the third pixel group, for example, the blue sub-pixels B. The data voltage VdataR/G/B may be applied to the first input nodes of the switch parts 151 and 152 through the output buffer 72 of the data driver 110. The black grayscale voltage Vblack may be applied to the second input nodes of the switch parts 151 and 152 through the output buffer 74 of the power supply 140.

When the switch circuit 300 is connected to the output terminals of the data driver 110, the number of channels of the data driver 110 may be reduced. As shown in FIG. 17, since the data voltage output from the data driver 110 may be applied to three data lines through the switch parts 151 and 152, the number of channels of the data driver 110 may be reduced to ⅓ compared to the number of data lines.

Each of the switch parts 151 and 152 includes first to ninth transistors M21 to M29 as shown in FIGS. 18A and 18B. The transistors M21 to M29 are turned on in response to the gate-on voltage Von of the switch signals SW1, SW2 and SW3, and are turned off in response to the gate-off voltage Voff of the switch signals SW1, SW2 and SW3. As illustrated in FIG. 19, the phases of the first switch signal SW1, the second switch signal SW2, and the third switch signal SW3 may be sequentially shifted. During the first sub-frame period SF1, the first switch signal SW1 is generated as a pulse of gate-on voltage Von, and the voltages of the second and third switch signals SW2 and SW3 are the gate-off voltage Voff. During the second sub-frame period SF2, the second switch signal SW2 is generated as a pulse of gate-on voltage Von, and the voltages of the first and third switch signals SW1 and SW3 are the gate-off voltage Voff. During the third sub-frame period SF3, the third switch signal SW3 is generated as a pulse of gate-on voltage Von, and the voltages of the first and second switch signals SW1 and SW2 are the gate-off voltage Voff.

The first transistor M21 is connected between the first input node to which the data voltage Vdata is applied and the first data line DL1 as shown in FIGS. 18A to 18C, and is turned on in response to the gate-on voltage Von of the first switch signal SW1. When the first transistor M21 is turned on, the data voltage VdataR may be applied to the sub-pixel SP1 of the first pixel group through the first data line DL1. The first transistor M21 includes a first electrode connected to the first input node, a second electrode connected to the first data line DL1, and a gate electrode connected to the first gate node to which the first switch signal SW1 is applied.

The second transistor M22 is connected between the second input node to which the black grayscale voltage Vblack is applied and the first data line DL1 as shown in FIGS. 18A to 18C, and is turned on in response to the gate-on voltage Von of the second switch signal SW2. When the second transistor M22 is turned on, the black grayscale voltage Vblack may be applied to the sub-pixel SP1 of the first pixel group through the first data line DL1. The second transistor M22 includes a first electrode connected to the second input node, a second electrode connected to the first data line DL1, and a gate electrode connected to the second gate node to which the second switch signal SW2 is applied.

The third transistor M23 is connected between the second input node and the first data line DL1 as shown in FIGS. 18A to 18C, and is turned on in response to the gate-on voltage Von of the third switch signal SW3. When the third transistor M23 is turned on, the black grayscale voltage Vblack may be applied to the sub-pixel SP1 of the first pixel group through the first data line DL1. The third transistor M23 includes a first electrode connected to the second input node, a second electrode connected to the first data line DL1, and a gate electrode connected to the third gate node to which the third switch signal SW3 is applied.

The fourth transistor M24 is connected between the second input node and the second data line DL2 as shown in FIGS. 18A to 18C, and is turned on in response to the gate-on voltage Von of the first switch signal SW1. When the fourth transistor M24 is turned on, the black grayscale voltage Vblack may be applied to the sub-pixel SP2 of the second pixel group through the second data line DL2. The fourth transistor M24 includes a first electrode connected to the second input node, a second electrode connected to the second data line DL2, and a gate electrode connected to the first gate node.

The fifth transistor M25 is connected between the first input node and the second data line DL2 as shown in FIGS. 18A to 18C, and is turned on in response to the gate-on voltage Von of the second switch signal SW2. When the fifth transistor M25 is turned on, the data voltage VdataG may be applied to the sub-pixel SP2 of the second pixel group through the second data line DL2. The fifth transistor M25 includes a first electrode connected to the first input node, a second electrode connected to the second data line DL2, and a gate electrode connected to the second gate node.

The sixth transistor M26 is connected between the second input node and the second data line DL2 as shown in FIGS. 18A to 18C, and is turned on in response to the gate-on voltage Von of the third switch signal SW3. When the sixth transistor M26 is turned on, the black grayscale voltage Vblack may be applied to the sub-pixel SP2 of the second pixel group through the second data line DL2. The sixth transistor M26 includes a first electrode connected to the second input node, a second electrode connected to the second data line DL2, and a gate electrode connected to the third gate node.

The seventh transistor M27 is connected between the second input node and the third data line DL3 as shown in FIGS. 18A to 18C, and is turned on in response to the gate-on voltage Von of the first switch signal SW1. When the seventh transistor M27 is turned on, the black grayscale voltage Vblack may be applied to the sub-pixel SP3 of the third pixel group through the third data line DL3. The seventh transistor M27 includes a first electrode connected to the second input node, a second electrode connected to the third data line DL3, and a gate electrode connected to the first gate node.

The eighth transistor M28 is connected between the second input node and the third data line DL3 as shown in FIGS. 18A to 18C, and is turned on in response to the gate-on voltage Von of the second switch signal SW2. When the eighth transistor M28 is turned on, the black grayscale voltage Vblack may be applied to the sub-pixel SP3 of the third pixel group through the third data line DL3. The eighth transistor M28 includes a first electrode connected to the second input node, a second electrode connected to the third data line DL3, and a gate electrode connected to the second gate node.

The ninth transistor M29 is connected between the first input node and the third data line DL3 as shown in FIGS. 18A to 18C, and is turned on in response to the gate-on voltage Von of the third switch signal SW3. When the ninth transistor M29 is turned on, the data voltage VdataB may be applied to the sub-pixel SP3 of the third pixel group through the third data line DL3. The ninth transistor M29 includes a first electrode connected to the first input node, a second electrode connected to the third data line DL3, and a gate electrode connected to the third gate node.

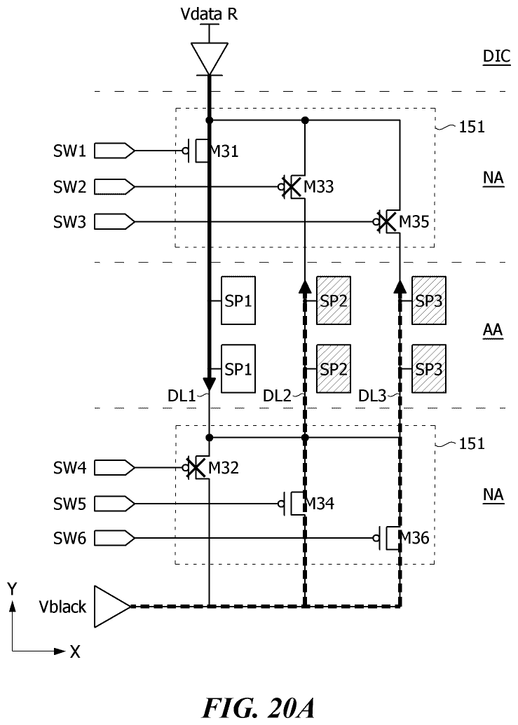

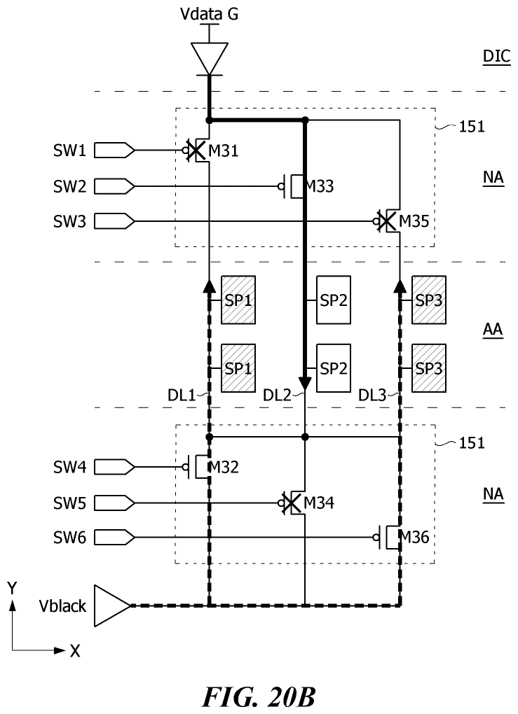

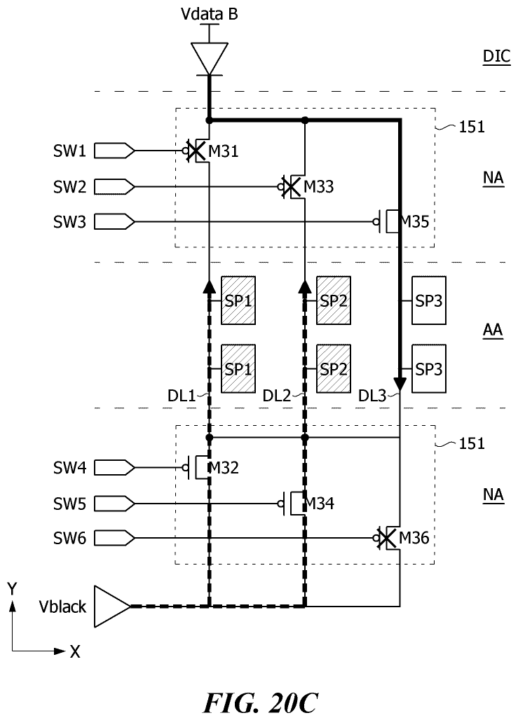

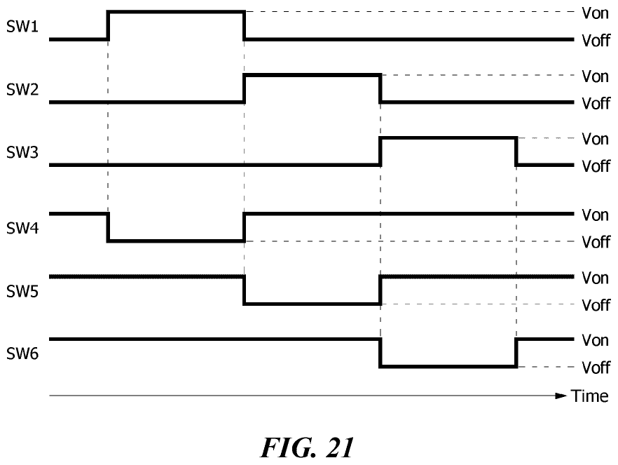

FIGS. 20A to 20C are diagrams showing other examples of the switch circuit illustrated in FIG. 17. In FIGS. 20A to 20C, ‘DIC’ indicates a drive IC in which the data driver 110 is integrated. The switch elements M31 to M36 of the switch circuit 300 may be arranged in, but not limited to, the non-display area NA of the display panel 100 as shown in FIGS. 20A to 20C. FIG. 21 is a waveform diagram showing an example of switch signals controlling the switch circuits illustrated in FIGS. 20A to 20C.

Referring to FIGS. 20A to 21, at least one of the switch parts 151 of the switch circuit 300 may include first to sixth transistors M31 to M36. The first, third and fifth transistors M31, M33 and M35 may be arranged in the non-display area NA on one side of the display panel 100, for example, the upper bezel area, and may supply data voltages VdataR, VdataG and VdataB to the data lines D1, D2 and D3. The second, fourth and sixth transistors M32, M34 and M36 may be arranged in the non-display area NA on the other side of the display panel 100, for example, the lower bezel area, and may supply the black grayscale voltage Vblack to the data lines D1, D2 and D3.

The transistors M31 to M36 are turned on in response to the gate-on voltage Von of the switch signals SW1 to SW6, and are turned off in response to the gate-off voltage Voff of the switch signals SW1 to SW6. As shown in FIG. 21, the phases of the first switch signal SW1, the second switch signal SW2, and the third switch signal SW3 may be sequentially shifted. During the first sub-frame period SF1, the first switch signal SW1 is generated as a pulse of gate-on voltage Von, and the voltages of the second and third switch signals SW2 and SW3 are the gate-off voltage Voff. During the second sub-frame period SF2, the second switch signal SW2 is generated as a pulse of gate-on voltage Von, and the voltages of the first and third switch signals SW1 and SW3 are the gate-off voltage Voff. During the third sub-frame period SF3, the third switch signal SW3 is generated as a pulse of gate-on voltage Von, and the voltages of the first and second switch signals SW1 and SW2 are the gate-off voltage Voff.

The fourth switch signal SW4 is generated as an antiphase signal of the first switch signal SW1. The fifth switch signal SW5 is generated as an antiphase signal of the second switch signal SW2. The sixth switch signal SW6 is generated as an antiphase signal of the third switch signal SW3. During the first sub-frame period SF1, the first switch signal SW1 is generated as a pulse of gate-on voltage Von, and the voltages of the second and third switch signals SW2 and SW3 are the gate-off voltage Voff. During the first sub-frame period SF1, the fourth switch signal SW4 is generated as a pulse of gate-off voltage Voff, and the voltages of the fifth and sixth switch signals SW5 and SW6 are the gate-on voltage Von. During the second sub-frame period SF2, the second switch signal SW2 is generated as a pulse of gate-on voltage Von, and the voltages of the first and third switch signals SW1 and SW3 are the gate-off voltage Voff. During the second sub-frame period SF2, the fifth switch signal SW5 is generated as a pulse of gate-off voltage Voff, and the voltages of the fourth and sixth switch signals SW4 and SW6 are the gate-on voltage Von. During the third sub-frame period SF3, the third switch signal SW3 is generated as a pulse of gate-on voltage Von, and the voltages of the first and second switch signals SW1 and SW2 are the gate-off voltage Voff. During the third sub-frame period SF3, the sixth switch signal SW6 is generated as a pulse of gate-off voltage Voff, and the voltages of the fourth and fifth switch signals SW4 and SW5 are the gate-on voltage Von.

The first transistor M31 is connected between the first input node to which the data voltages VdataR, VdataG and VdataB are applied and the first data line DL1, and is turned on in response to the gate-on voltage Von of the first switch signal SW1. The first input node may be formed in the non-display area NA on one side and may be connected to the output terminal of the data driver 110. When the first transistor M31 is turned on, the first data voltage VdataR may be applied to the sub-pixel SP1 of the first pixel group through the first data line DL1 as illustrated in FIG. 20A. The first transistor M31 includes a first electrode connected to the first input node, a second electrode connected to the data line DL1 of the first pixel group, and a gate electrode connected to the first gate node to which the first switch signal SW1 is applied. The first gate node may be formed in the non-display area NA on one side and may be connected to the first switch signal line to which the first switch signal SW1 is applied.

The second transistor M32 is connected between the second input node to which the black grayscale voltage Vblack is applied and the first data line DL1, and is turned on in response to the gate-on voltage Von of the fourth switch signal SW4. The second input node may be formed in the non-display area NA on the other side and may be connected to the output terminal of the power supply 140. When the second transistor M32 is turned on, the black grayscale voltage Vblack may be applied to the sub-pixel SP1 of the first pixel group through the first data line DL1 as shown in FIGS. 20B and 20C. The second transistor M32 includes a first electrode connected to the second input node, a second electrode connected to the first data line DL1, and a gate electrode connected to the fourth gate node to which the fourth switch signal SW4 is applied. The fourth gate node may be formed in the non-display area NA on the other side and may be connected to the fourth switch signal line to which the fourth switch signal SW4 is applied.

The third transistor M33 is connected between the first input node and the second data line DL2, and is turned on in response to the gate-on voltage Von of the second switch signal SW2. When the third transistor M33 is turned on, the second data voltage VdataG may be applied to the sub-pixel SP2 of the second pixel group through the second data line DL2 as shown in FIG. 20B. The third transistor M33 includes a first electrode connected to the first input node, a second electrode connected to the second data line DL2, and a gate electrode connected to the second gate node to which the second switch signal SW2 is applied. The second gate node may be formed in the non-display area NA on one side and may be connected to the second switch signal line to which the second switch signal SW2 is applied.

The fourth transistor M34 is connected between the second input node and the second data line DL2, and is turned on in response to the gate-on voltage Von of the fifth switch signal SW5. When the fourth transistor M34 is turned on, the black grayscale voltage Vblack may be applied to the sub-pixel SP2 of the second pixel group through the second data line DL2 as shown in FIGS. 20A and 20C. The fourth transistor M34 includes a first electrode connected to the second input node, a second electrode connected to the second data line DL2, and a gate electrode connected to the fifth gate node to which the fifth switch signal SW5 is applied. The fifth gate node may be formed in the non-display area NA on the other side and may be connected to the fifth switch signal line to which the fifth switch signal SW5 is applied.

The fifth transistor M35 is connected between the first input node and the third data line DL3, and is turned on in response to the gate-on voltage Von of the third switch signal SW2. When the fifth transistor M35 is turned on, the third data voltage VdataB may be applied to the sub-pixel SP3 of the third pixel group through the third data line DL3 as shown in FIG. 20C. The fifth transistor M35 includes a first electrode connected to the first input node, a second electrode connected to the third data line DL3, and a gate electrode connected to the third gate node to which the third switch signal SW3 is applied. The third gate node may be formed in the non-display arca NA on one side and may be connected to the third switch signal line to which the third switch signal SW3 is applied.

The sixth transistor M36 is connected between the second input node and the third data line DL3, and is turned on in response to the gate-on voltage Von of the sixth switch signal SW6. When the sixth transistor M36 is turned on, the black grayscale voltage Vblack may be applied to the sub-pixel SP3 of the third pixel group through the third data line DL3 as shown in FIGS. 20A and 20B. The sixth transistor M36 includes a first electrode connected to the second input node, a second electrode connected to the third data line DL3, and a gate electrode connected to the sixth gate node to which the sixth switch signal SW6 is applied. The sixth gate node may be formed in the non-display area NA on the other side and may be connected to the sixth switch signal line to which the sixth switch signal SW6 is applied.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display panel comprising:
data lines of a first pixel group connected to receive a first data voltage during a first sub-frame period and a black grayscale voltage during a second sub-frame period;
data lines of a second pixel group connected to receive the black grayscale voltage during the first sub-frame period and a second data voltage during the second sub-frame period;
sub-pixels of the first pixel group connected to the data lines of the first pixel group; and
sub-pixels of the second pixel group connected to the data lines of the second pixel group.

2. The display panel of claim 1, wherein:
during an emission period of the first sub-frame period, the sub-pixels of the first pixel group are turned on, and the sub-pixels of the second pixel group are turned off; and
during an emission period of the second sub-frame period, the sub-pixels of the first pixel group are turned off, and the sub-pixels of the second pixel group are turned on.

3. The display panel of claim 2, wherein:
during a data addressing period of the first sub-frame period, the first data voltage is applied to the sub-pixels of the first pixel group, and the black grayscale voltage is applied to the sub-pixels of the second pixel group at the same time; and
during a data addressing period of the second sub-frame period, the black grayscale voltage is applied to the sub-pixels of the first pixel group, and the second data voltage is applied to the sub-pixels of the second pixel group at the same time.

4. The display panel of claim 1, further comprising:
a switch circuit that is connected to a first input node to which the first data voltage and the second data voltage are applied, a second input node to which the black grayscale voltage is input, gate nodes to which switch signals are applied, the data lines of the first pixel group, and the data lines of the second pixel group.

5. The display panel of claim 4, wherein the switch circuit includes:
a first switch part connected to a data line connected to a sub-pixel of a first color of a first pixel, and a data line connected to a sub-pixel of the first color of a second pixel adjacent to the first pixel;
a second switch part connected to a data line connected to a sub-pixel of a second color of the first pixel, and a data line connected to a sub-pixel of the second color of the second pixel; and
a third switch part connected to a data line connected to a sub-pixel of a third color of the first pixel, and a data line connected to a sub-pixel of the third color of the second pixel.

6. The display panel of claim 5, wherein each of the switch parts includes:
a first transistor connected between the first input node and a data line of the first pixel group and turned on in response to a gate-on voltage of a first switch signal;
a second transistor connected between the second input node and a data line of the first pixel group and turned on in response to a gate-on voltage of a second switch signal;
a third transistor connected between the second input node and a data line of the second pixel group and turned on in response to the gate-on voltage of the first switch signal; and
a fourth transistor connected between the first input node and a data line of the second pixel group and turned on in response to the gate-on voltage of the second switch signal.

7. A display panel comprising:
data lines of a first pixel group connected to receive a first data voltage during a first sub-frame period and a black grayscale voltage during a second sub-frame period and a third sub-frame period;
data lines of a second pixel group connected to receive a second data voltage during the second sub-frame period and the black grayscale voltage during the first sub-frame period and the third sub-frame period;
data lines of a third pixel group connected to receive a third data voltage during the third sub-frame period and the black grayscale voltage during the first sub-frame period and the second sub-frame period;
sub-pixels of the first pixel group connected to the data lines of the first pixel group;
sub-pixels of the second pixel group connected to the data lines of the second pixel group; and
sub-pixels of the third pixel group connected to the data lines of the third pixel group.

8. The display panel of claim 7, wherein:
during an emission period of the first sub-frame period, the sub-pixels of the first pixel group are turned on, and the sub-pixels of the second pixel group and the sub-pixels of the third pixel group are turned off;
during an emission period of the second sub-frame period, the sub-pixels of the second pixel group are turned on, and the sub-pixels of the first pixel group and the sub-pixels of the third pixel group are turned off; and
during an emission period of the third sub-frame period, the sub-pixels of the third pixel group are turned on, and the sub-pixels of the first pixel group and the sub-pixels of the second pixel group are turned off.

9. The display panel of claim 8, wherein:
during a data addressing period of the first sub-frame period, the first data voltage is applied to the sub-pixels of the first pixel group, and the black grayscale voltage is applied to the sub-pixels of the second pixel group and the sub-pixels of the third pixel group at the same time;
during a data addressing period of the second sub-frame period, the second data voltage is applied to the sub-pixels of the second pixel group, and the black grayscale voltage is applied to the sub-pixels of the first pixel group and the sub-pixels of the third pixel group at the same time; and
during a data addressing period of the third sub-frame period, the third data voltage is applied to the sub-pixels of the third pixel group, and the black grayscale voltage is applied to the sub-pixels of the first pixel group and the sub-pixels of the second pixel group at the same time.

10. The display panel of claim 7, further comprising:
a switch circuit that is connected to a first input node to which the first data voltage, the second data voltage, and the third data voltage are applied, a second input node to which the black grayscale voltage is input, gate nodes to which switch signals are applied, the data lines of the first pixel group, the data lines of the second pixel group, and the data lines of the third pixel group.

11. The display panel of claim 10, wherein the switch circuit includes:
a first transistor connected between the first input node and a data line of the first pixel group and turned on in response to a gate-on voltage of a first switch signal;
a second transistor connected between the second input node and a data line of the first pixel group and turned on in response to a gate-on voltage of a second switch signal;
a third transistor connected between the second input node and a data line of the first pixel group and turned on in response to a gate-on voltage of a third switch signal;
a fourth transistor connected between the second input node and a data line of the second pixel group and turned on in response to the gate-on voltage of the first switch signal;
a fifth transistor connected between the first input node and a data line of the second pixel group and turned on in response to the gate-on voltage of the second switch signal;
a sixth transistor connected between the second input node and a data line of the second pixel group and turned on in response to the gate-on voltage of the third switch signal;
a seventh transistor connected between the second input node and a data line of the third pixel group and turned on in response to the gate-on voltage of the first switch signal;
an eighth transistor connected between the second input node and a data line of the third pixel group and turned on in response to the gate-on voltage of the second switch signal; and
a ninth transistor connected between the first input node and a data line of the third pixel group and turned on in response to the gate-on voltage of the third switch signal.

12. The display panel of claim 10, wherein the switch circuit includes:
a first transistor connected between the first input node and a data line of the first pixel group and turned on in response to a gate-on voltage of a first switch signal;
a second transistor connected between the second input node and a data line of the first pixel group and turned on in response to a gate-on voltage of a fourth switch signal;
a third transistor connected between the first input node and a data line of the second pixel group and turned on in response to a gate-on voltage of a second switch signal;
a fourth transistor connected between the second input node and a data line of the second pixel group and turned on in response to a gate-on voltage of a fifth switch signal;
a fifth transistor connected between the first input node and a data line of the third pixel group and turned on in response to a gate-on voltage of a third switch signal; and
a sixth transistor connected between the second input node and a data line of the third pixel group and turned on in response to a gate-on voltage of a sixth switch signal.

13. A display device comprising:
a display panel including data lines of a first pixel group, data lines of a second pixel group, sub-pixels of the first pixel group connected to the data lines of the first pixel group, and sub-pixels of the second pixel group connected to the data lines of the second pixel group;
a data driver configured to output a first data voltage and a second data voltage; and
a switch circuit configured to supply a black grayscale voltage to the data lines of the first pixel group and the data lines of the second pixel group,
wherein the first data voltage is configured to be applied to the data lines of the first pixel group during a first sub-frame period, and the black grayscale voltage is configured to be applied to the data lines of the first pixel group during a second sub-frame period, and
wherein the black grayscale voltage is configured to be applied to the data lines of the second pixel group during the first sub-frame period, and then the second data voltage is configured to be applied to the data lines of the second pixel group during the second sub-frame period.

14. The display device of claim 13, wherein the switch circuit is arranged in a non-display area of the display panel.

15. The display device of claim 13, wherein the data driver and the switch circuit are embedded in an integrated circuit.

16. The display device of claim 13, wherein:
during an emission period of the first sub-frame period, the sub-pixels of the first pixel group are turned on, and the sub-pixels of the second pixel group are turned off; and
during an emission period of the second sub-frame period, the sub-pixels of the first pixel group are turned off, and the sub-pixels of the second pixel group are turned on.

17. The display device of claim 16, wherein:
during a data addressing period of the first sub-frame period, the first data voltage is applied to the sub-pixels of the first pixel group, and the black grayscale voltage is applied to the sub-pixels of the second pixel group at the same time; and
during a data addressing period of the second sub-frame period, the black grayscale voltage is applied to the sub-pixels of the first pixel group, and the second data voltage is applied to the sub-pixels of the second pixel group at the same time.
